(19) United States
(12) Patent Application Publication
(10) Pub. No.: US 2018/0007436 A1
(43) Pub. Date: Jan. 4, 2018

(54) Method and System for Dynamically Providing Personalized Channel Package for Multimedia Services to User

(71) Applicant: Wipro Limited, Bangalore (IN)

(72) Inventors: Tinku Malayil JOSE, Bangalore (IN); Manish Verma, Bangalore (IN)

(73) Assignee: Wipro Limited

(21) Appl. No.: 15/270,267

(22) Filed: Sep. 20, 2016

(30) Foreign Application Priority Data
Jun. 30, 2016 (IN) 201641022545

(51) Int. Cl. H04N 21/45; H04N 21/442; H04N 21/2385

(52) U.S. Cl. CPC H04N 21/4532; H04N 21/2385; H04N 21/44222

(57) ABSTRACT

Disclosed herein is method and system for dynamically providing personalized channel package for multimedia services to user. The method comprises retrieving a default channel map from a data source associated with service provider of the multimedia services. Then the method obtains a user viewing pattern and various channel recommendation factors related to user and the channels. Thereafter, a personalized context data of the user is generated by correlating the viewing pattern and the channel recommendation factors. Finally, the method generates and provides the personalized channel package to the user based on the personalized context data and the default channel map, thereby providing flexibility to the user for dynamically selecting, subscribing and managing the channels. Further, the method also determines an optimal cost for the personalized channel package and allows the user to perform real-time modifications to the channel package for further reducing the cost of the channel package.

### TECHNICAL FIELD

The present subject matter is related, in general to multimedia services, and more particularly, but not exclusively to a method and system for dynamically providing personalized channel package for multimedia services to a user.

### BACKGROUND

A television channel is a physical or virtual channel over which a television station or television network is distributed. The television channels may be shared by different television stations or cable-distributed channels depending on the location of the service providers. A service provider, also called a media service provider, is an organization that complements its regular business by providing a set of media services to one or more customers and/or subscribers.

In a day-to-day scenario, the media service providers provide either a pre-built channel package for viewing the media services across one or more customer devices or provide a readymade list of channels for subscription on the various customer devices. Thus the customers have a limited choice of subscribing one or more media channels from the given channel package or the readymade channel list provided to them. Also, most customers are currently demanding for flexibility in choosing the media services and presenting them in a more convenient manner.

In a conventional approach a service provider of the multimedia services analyzes ratings for the media services being telecasted in a channel and determines the appropriate schedule or program lineup to be presented to the customers based on the ratings. However, the above approach does not allow the customers to select media services of their own choice and to build a personalized channel package. Also, presently there is no system available which allows the personalized packaging of channels based on the customer's viewing patterns, interests and habits.

The challenges mainly faced in dynamically providing a personalized channel package for multimedia services to the users includes collecting, analyzing the viewing pattern of the users, building up a personalized context of the user and providing an optimal and personalized channel package to the user based on the personalized context.

### SUMMARY

Disclosed herein is a method and system for dynamically providing a personalized channel package for multimedia services to a user. A default channel map and a corresponding viewing pattern of the user are obtained from a service provider of the multimedia services. A personalized context data of the user is generated using one or more details associated with the user and the viewing pattern of the user. Then a personalized channel package is generated based on the personalized context data of the user. The personalized channel package comprises one or more channels that may be of utmost interest to the user.

Accordingly, the present disclosure relates to a method for dynamically providing a personalized channel package for multimedia services to a user. The method comprises the steps of retrieving a default channel map from a data source associated with a service provider of multimedia services. The default channel map comprises list of one or more channels providing multimedia services to the user. The method also comprises obtaining a viewing pattern of the user and one or more channel recommendation factors related to the user and the one or more channels. Thereafter, the method generates a personalized context data of the user by correlating the viewing pattern and the one or more channel recommendation factors. Further, the method generates the personalized channel package based on the personalized context data of the user and the default channel map. Finally, the method provides the personalized channel package to the user.

Further, the present disclosure relates to a channel package generator for dynamically providing a personalized channel package for multimedia services to a user. The channel package generator comprises a processor and a memory communicatively coupled to the processor. The memory stores processor-executable instructions, which, on execution, causes the processor to one or more operations comprising retrieving a default channel map from a data source associated with a service provider of multimedia services. The default channel map comprises list of one or more channels providing multimedia services to the user. The system obtains a viewing pattern of the user and one or more channel recommendation factors related to the user and the one or more channels. Thereafter the system generates a personalized context data of the user by correlating the viewing pattern and the one or more channel recommendation factors. Further, the system generates the personalized channel package based on the personalized context data of the user with the default channel map. Finally the system provides the personalized channel package to the user.

In another embodiment, a non-transitory computer-readable storage medium for dynamically providing personalized channel package for multimedia services to user is disclosed, which when executed by a computing device, cause the computing device to perform operations including retrieving a default channel map from a data source associated with a service provider of multimedia services. The default channel map includes list of one or more channels providing multimedia services to the user. The operations further include obtaining a viewing pattern of the user and one or more channel recommendation factors related to the user and the one or more channels. Thereafter the operation includes generating a personalized context data of the user by correlating the viewing pattern and the one or more channel recommendation factors. Further, the operations include generating the personalized channel package based on the personalized context data of the user with the default channel map. Finally the operations include providing the personalized channel package to the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1A shows an exemplary environment illustrating a channel package generator for dynamically providing a personalized channel package for multimedia services to a user in accordance with some embodiments of the present disclosure;

FIG. 1B shows a block diagram of an exemplary CPE device interfaced with the one or more user devices in accordance with some embodiments of the present disclosure;

FIG. 2A shows a detailed block diagram illustrating the channel package generator in accordance with some embodiments of the present disclosure;

FIG. 2B illustrates a method of evaluating and generating a context of the user based on one or more channel recommendation factors in accordance with few embodiments of the present disclosure;

FIG. 2C shows an exemplary representation the personalized context data of the user in accordance with few embodiments of the present disclosure;

FIG. 3 shows a flowchart illustrating a method for dynamically providing a personalized channel package for multimedia services to a user in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and system for dynamically providing a personalized channel package for multimedia services to a user. Initially, the method retrieves a default channel map from a data source associated with the service provider. The default channel map is a list of channels that are provided by the service provider of the multimedia services. Then the method obtains a viewing pattern of the user along with one or more channel recommendation factors related to the user and the one or more channels. A personalized context data of the user is generated based on the viewing pattern and the one or more channel recommendation factors. The one or more channel recommendation factors may include, without limitation, demographic details related to the user, one or more events occurring in nearby location of the user, favorite multimedia services viewed by the user, time of telecast of the multimedia services, subscription cost of the one or more channels, trend in the multimedia services and social media activities related to the user and the one or more channels. In an embodiment, the one or more channel recommendation factors may be obtained from one or more external sources including, but not limiting to, social media, multimedia metadata sources and the service provider. Subsequently, the method generates the personalized channel package for the user based on the personalized context data of the user and the default channel map associated with the user. Finally, the personalized channel package is provided to the user. In an embodiment, the channel package generator may also allow the user to dynamically subscribe to one or more channels even when the one or more channels that are occasionally viewed by the user are not included in the personalized channel package.

In an embodiment, the channel package generator allows the user to dynamically modify the personalized channel package provided to the user during a billing period, thereby providing flexibility to the user to get the most out of his time and money. The method also includes performing one or more time-based modifications on the personalized channel package in order to determine an optimal cost of subscription to the user. On the other hand, the channel package generator may also be used as an adaptable framework at the service providers' end. Here, the channel package generator enables the service providers to generate a context based channel package to each user, thereby improving the net customer satisfaction score (CSAT) and increasing the Average Revenue per User (ARPU) during a billing period. Further, the amount of time that a user spends in viewing the one or more channels and/or multimedia services may also be increased since the personalized channel package is provided to the user which is based on the interest of the user.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

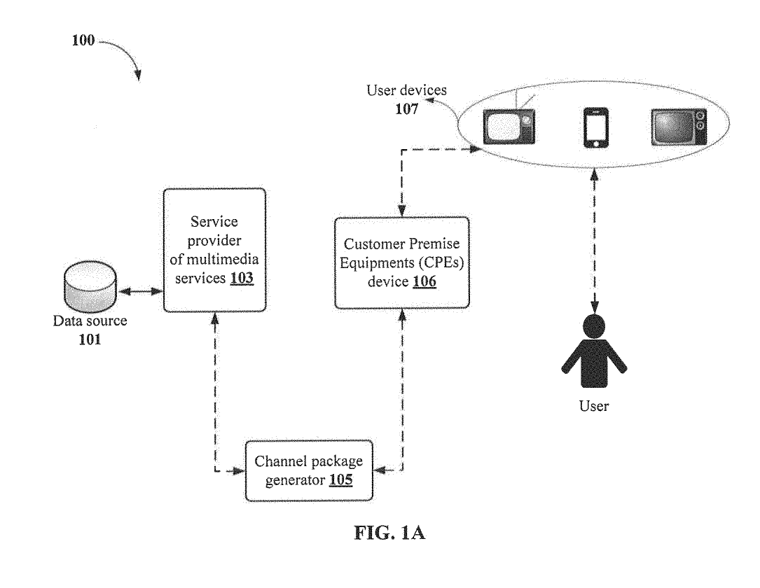

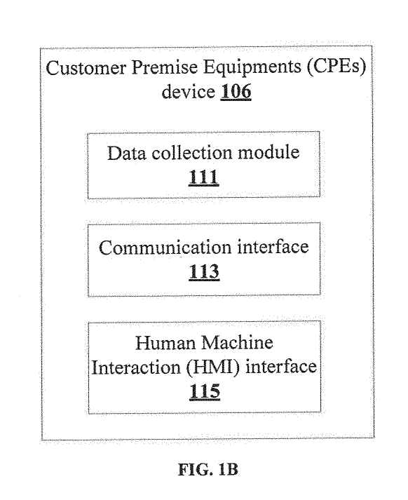

FIG. 1A shows an exemplary environment illustrating a channel package generator for dynamically providing a personalized channel package for multimedia services to a user.

The environment 100 comprises a service provider 103 of the multimedia services (referred as service provider 103 hereinafter), the channel package generator 105, a Customer Premises Equipment (CPE) device 106, a user of the multimedia services and one or more user devices 107 associated to the user for viewing the multimedia services. The data source 101 may be a repository for persistently storing and managing collections of data related to the service provider 103, the one or more channels provided by the service provider 103, the multimedia services and the users of the multimedia services. In an embodiment, the data source 101 may be configured with a data sorting technique for sorting and classifying various types of data stored in the data source 101. In an embodiment, the data source 101 may be placed in association with a computing system of the service provider 103. In another embodiment, the data source 101 may be placed in a centralized server associated with the service provider 103.

The channel package generator 105 communicates with the service provider 103 for loading and/or retrieving a default channel map 211 from the data source 101. Further, the channel package generator 105 obtains a viewing pattern 213 and one or more channel recommendation factors 217 using the data source 101 and the CPE device 106. As an example, the CPE device 106 may include, but not limited to, a television set-top box, a telephone handset, a home gateway, a subscriber router and one or more switches. In an embodiment, the CPE device 106 may be a software component interfaced between the channel package generator 105 and the one or more user devices 107, which is responsible for collecting information related to the user through the one or more user devices 107 and interfacing with the user. The one or more user devices 107 are the various devices used by the user for subscribing, managing and viewing the multimedia services provided from the service provider 103. As an example, the one or more user devices 107 may include, without limitation, a television, a computing device, a mobile computing device and the similar.

In an embodiment channel package generator 105 correlates the viewing pattern 213 and the one or more channel recommendation factors 217 for generating a personalized context data 219 of the user. As an example, the personalized context data 219 may include, without limitation, list of multimedia services viewed by the users, social media data of the user and the behavioural information related to the user. The personalized context data 219 may be one of the critical data for generating the personalized channel package for the multimedia services. The personalized channel package may be generated based on the personalized context data 219 of the user and the default channel map 211 obtained from the service provider 103. In an embodiment, the channel package generator 105 may use one or more predetermined algorithms for may be applied on the personalized context data 219 of the user for generating the personalized channel package for the user. Finally the channel package generator 105 provides the personalized channel package to the user through the CPE device 106.

FIG. 1B shows a block diagram of an exemplary CPE device interfaced with the one or more user devices in accordance with some embodiments of the present disclosure.

In an embodiment, the channel package generator 105 interfaces with the CPE device 106. The CPE device 106 may comprise a data collection module 111, a communication interface 113 and a Human Machine Interaction (HMI) interface 115 as shown in FIG. 1B. As an example, the data collection module 111 configured in the CPE device 106 helps in collecting the user viewing pattern 213, one or more favourite channels viewed by the user and other information related to the user through the one or more user devices 107. The communication interface 113 configured in the CPE device 106 may be used for relaying the data collected by the data collection module 111 to the channel package generator 105. The communication interface 113 may also be used for communicating one or more notifications and responses between the service provider 103 and the user. The HMI interface configured in the CPE device 106 may be used for providing an interface to the user to view and select and one or more channels that are of interest to the user, through the one or more user devices 107.

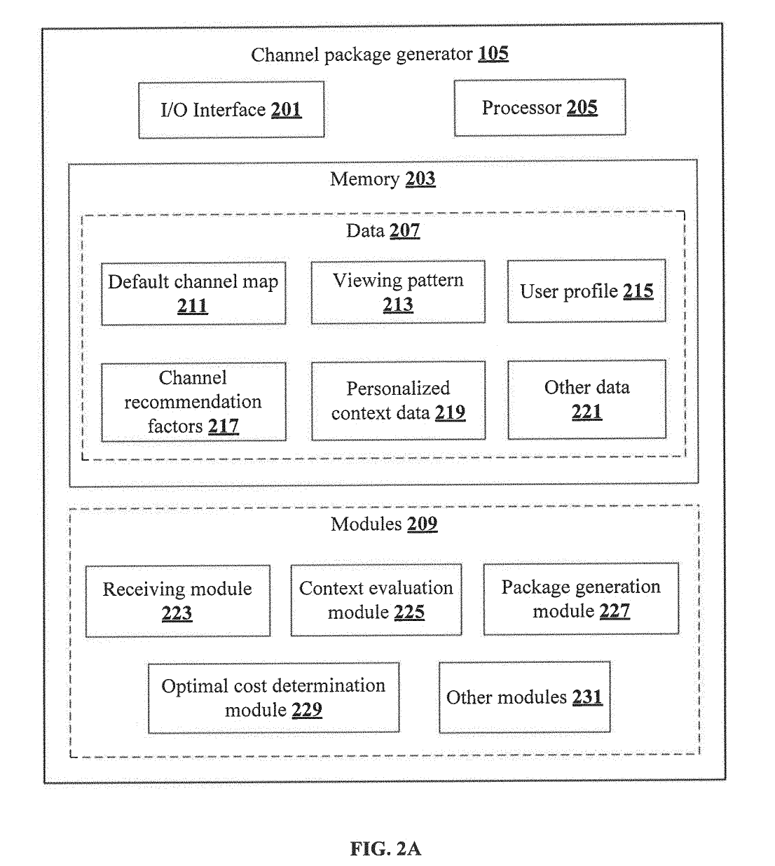

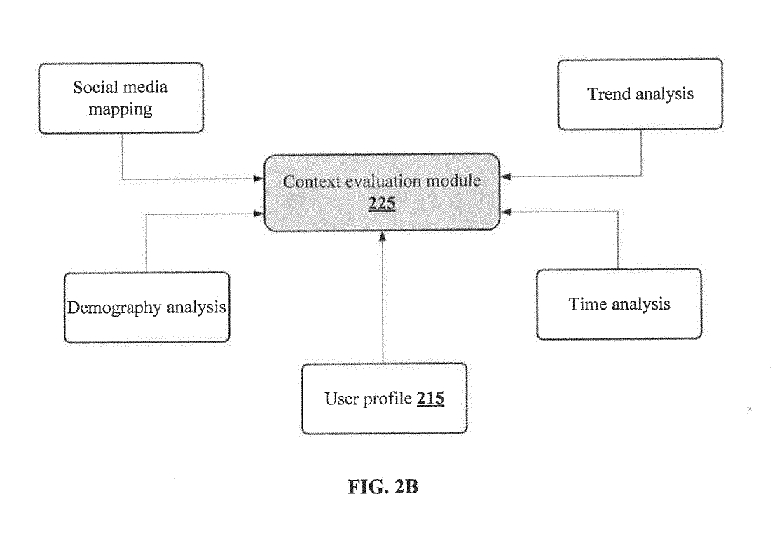

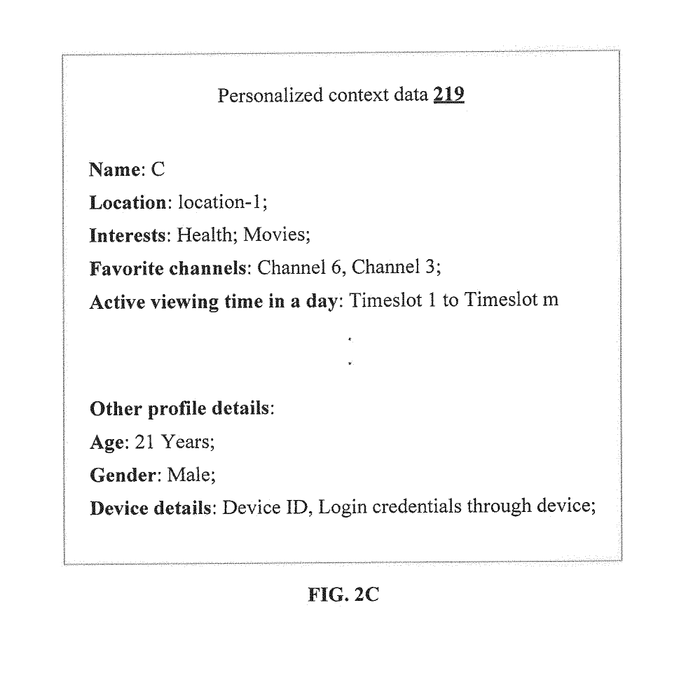

FIG. 2A shows a detailed block diagram illustrating the channel package generator in accordance with some embodiments of the present disclosure.

The channel package generator 105 comprises an I/O interface 201, a memory 203 and a processor 205. The I/O interface 201 is configured to receive one or more data, including the default channel map 211, the viewing pattern 213 and the one or more channel recommendation factors 217 from the service provider 103 and the CPE device 106 associated with the one or more user devices 107. The memory 203 is communicatively coupled to the processor 205. The processor 205 is configured to perform one or more functions of the channel package generator 105 for dynamically providing the personalized channel package for the multimedia services to the user. In one implementation, the channel package generator 105 comprises data 207 and modules 209 for performing various operations in accordance with the embodiments of the present disclosure. In an embodiment, the data 207 may include, without limitation, the default channel map 211, the viewing pattern 213, the user profile 215, the one or more channel recommendation patterns 217, the personalized context data 219 and other data 221.

In one embodiment, the data 207 may be stored within the memory 203 in the form of various data structures. Additionally, the aforementioned data 207 can be organized using data models, such as relational or hierarchical data models. The other data 221 may store data, including temporary data and temporary files, generated by modules 209 for performing the various functions of the channel package generator 105.

In an embodiment, the default channel map 211 represents a list of one or more channels that are made available to the users who are registered with the service provider 103. The users may also select and subscribe to one or more specific channels in the default channel map 211 based on their interests and requirements. In an instance, the default channel map 211 may also indicate cost of subscription of each of the one or more channels listed in the default channel map 211 along with the time based line-up of multimedia services and/or programs associated with each of the one or more channels.

In an embodiment, the viewing pattern 213 is a time based sequence of channels viewed by the user. The viewing pattern 213 discloses details like amount of time the user has spent viewing a particular channel, the type of multimedia services watched frequently by the user and similar information across the one or more user devices 107 used by the user. The viewing pattern 213 may be obtained based on the time, in which the user has viewed a multimedia service, based on the one or more channels viewed by the user, based on profile 215 of the user and based on the one or more devices used by the user.

In an embodiment, the user profile 215 comprises one or more details comprising, without limiting to, age of the user, gender of the user, ethnicity of the user, geographic location of the user and login information of the user. Further, the user profile 215 may comprise details related to the number and type of the user devices 107 used by the user, demographic information of the user and privacy policies of the user. The user profile 215 is a critical input in evaluating and generating the personalized context data 219 of the user. For instance, the personalized context data 219 generated by the channel package generator 105 may be entirely different for two users who belong to two different geographic locations and different ethnicity.

As an example, the personalized context data 219 corresponding to a user, ‘User A’ who is located in India, at an age of 21 years may be different from the personalized context data 219 corresponding to another user, ‘User B’ located in USA, belonging to the similar age group as of ‘User A’. In the above scenario, the personalized channel package for ‘User A’, which is generated based on the personalized context data 219 of ‘User A’, may include one or more channels that telecast a live Cricket match, considering that the users of similar age group like the sport “Cricket” in India (based on location details of ‘User A’). On the other hand, the personalized channel package for ‘User B’, which is generated based on the personalized context data 219 of ‘User B’ may include one or more channels that telecast a live Baseball contest, considering that the users of similar age group like the sport “Baseball” in USA (based location details of ‘User B’).

In an embodiment, the one or more channel recommendation factors 217 are related to the user and the one or more channels provided by the service provider 103. The one or more channel recommendation factors 217 include, without limitation, demographic details related to the user, one or more events occurring in nearby location of the user, favorite multimedia services viewed by the user, time of telecast of the multimedia services, subscription cost of the one or more channels, trend in the multimedia services and social media activities related to the user and the one or more channels. In an embodiment, the channel package generator 105 correlates the one or more recommendation data with the viewing pattern 213 of the user for generating the personalized context data 219 of the user.

In an embodiment, the personalized context data 219 of the user acts as a critical input to the channel package generator 105 for determining the personalized aspects of the channel packaging. As an example, the channel package generator 105 may build the personalized context data 219 of the user based on the viewing pattern 213 and the information related to the user and the multimedia services. The information that are used for generating the personalized context data 219 of the user may include, without limitation, social media activities of the user, demographic information of the user, details in the user profile 215, trends in the multimedia services and the time-based viewing pattern 213 of the user. FIG. 2C shows an exemplary representation of the personalized context data 219 for a user, ‘User C’ in accordance with some embodiments explained hereinabove. In an embodiment, the information comprised in the personalized context data 219 of ‘User C’ is not limited to the representation of FIG. 2C and the same may be modified dynamically when the interests of the user and/or the trends in the multimedia services change.

In an embodiment, the data 207 may be processed by one or more modules 209 of the personalized package generation module 227. In one implementation, the one or more modules 209 may also be stored as a part of the process 123. In an example, the one or more modules 209 may be communicatively coupled to the processor 205 for performing one or more functions of the personalized package generation module 227.

In one implementation, the one or more modules 209 may include, without limitation, a receiving module 223, a context evaluation module 225, a package generation module 227, an optimal cost determination module 229 and other modules 231. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the receiving module 223 may be configured to retrieve the default channel map 211 from the service provider 103 of the multimedia services. The receiving module 223 may also be used for obtaining the viewing pattern 213 and the one or more channel recommendation factors 217 associated with the user and the one or more channels. As an example, the receiving module 223 may communicate with the communication interface 113 of the CPE device 106 for receiving the data collected by the one or more user devices 107. In an embodiment, the receiving module 223 may adopt a communication technique such as, the RxTx communicator that defines various communication protocols and interfaces for receiving and transmitting the data to and from the one or more user devices 107.

In an embodiment, the context evaluation module 225 may be used for generating the personalized context data 219 of the user based on the one or more details related to the user and the one or more channels viewed by the user including, without limiting to, the social media activities of the user, demographic information of the user, the user profile 215, trends in the multimedia services and the time-based viewing pattern 213 of the user as shown in FIG. 2B.

As an example, the context evaluation module 225 may record one or more promotional events and advertisements related to the one or more channels from various social media sites associated with the user. Then the context evaluation module 225 may analyze and classify the recorded social media activities/data and the same may be mapped with the viewing pattern 213 of the user for dynamically building the personalized context data 219 of the user. FIG. 2C shows an exemplary representation the personalized context data 219 of the user, ‘User C’. As explained in the earlier section, the personalized context data 219 of ‘User C’ comprises one or more details including, without limiting to, the name of the user, details of the location of the user, personal interests of the user, favorite channels viewed by the user, time of the day in which the user likes to view the multimedia services and the other profile details in the user profile 215 of ‘User C’.

In an embodiment, the package generation module 227 is responsible for generating the personalized channel package for the multimedia services to the user. The package generation module 227 may generate the personalized channel package for the user based on the personalized context data 219 and the default channel map 211 retrieved from the service provider 103. As an example, consider Table A below, which shows an exemplary default channel map 211 retrieved from the service provider 103.

TABLE A
Default channel map

| | Channels | | | | | | |
|---|---|---|---|---|---|---|---|
| | Channel 1 | | Channel 2 | | | Channel n | |
| | Ratings | | Rating | | | Rating | |
| Time of telecast | (out of 10) | Cost | (out of 10) | Cost | | (out of 10) | Cost |
| Timeslot 1 | MS1_C1 | | MS1_C2 | | . . . | MS1_Cn | |
| | 9 | Rs. 180 | 8 | Rs. 240 | | | |
| Timeslot 2 | MS2_C1 | | MS2_C2 | | | MS2_Cn | |
| | 7 | Rs. 160 | 6 | Rs. 180 | | | |
| Timeslot 3 | MS3_C1 | | MS3_C2 | | | MS3_Cn | |
| | 5 | Rs. 100 | 4 | Rs. 120 | | | |
| . | | | | | | | |
| . | | | | | | | |
| . | | | | | | | |
| Timeslot m | MSm_C1 | | MSm_C2 | | | MSm_Cn | |
| | X1 | Y1 | X2 | Y2 | | X3 | Y3 |

As shown in Table A, the default channel map 211 may comprise one or more channels (represented as Channel 1, . . . , Channel n) that provide various multimedia services to the user at one or more different time intervals in a day (represented as Timeslot 1, . . . , Timeslot m). In an embodiment, a multimedia service provided by a channel, ‘Channel 1’ at a given timeslot, ‘Timeslot 1’ is represented as ‘MS_C1’ in Table A. In an embodiment, the default channel map 211 may also represent one or more details pertaining to each of the multimedia services that are telecasted in the one or more channels, Channel 1 to Channel n. As an example, Table A shows two other factors related to each of the multimedia services namely, user ratings (a measure of popularity of a particular multimedia service) and the cost of subscription of each of the multimedia services. The user may consider these additional factors associated with each of the multimedia services for determining and selecting a most suitable multimedia service. As an example, in order to generate a personalized channel package for ‘User C’, the package generation module 227 may use the personalized context data 219 of ‘User C’ (shown in FIG. 2C) and the default channel map 211 (shown in Table A) retrieved from the service provider 103. Here, the package generation module 227 identifies and selects the one or more multimedia services, belonging to the one or more channels, from the default channel map 211, such that the selected multimedia services correspond to the personalized context data 219 of ‘User C’. An exemplary personalized channel package, provided to ‘User C’ may be represented by the Table B below.

TABLE B
Personalized channel package

| Timeslot 1 | Timeslot 2 | Timeslot 3 | . . . | Timeslot m |
|---|---|---|---|---|
| MS4_C6 | MS2_C3 | MS1_C1 | . . . | MSx_Cy |
| Event: Yoga | Event: Regional | Event: An action | | Event: |
| workout | Utsav | thriller movie | | |
| Length: 1.00 | Length: 2.00 | Length: 2.30 | | Length: |
| Hrs. | Hrs. | Hrs. | | |

As shown in Table B, the personalized channel package generated for ‘User C’ comprises the one or more multimedia services that are selected by the channel package generator 105 based on the personalized context data 219 of ‘User C’. As an example, the personalized channel package may include a multimedia service ‘MS4_C6’ (a multimedia service telecasted at ‘Timeslot 4’ of ‘Channel 6’) to be viewed at a timeslot, ‘Timeslot 1’ of the day. Here, the multimedia service ‘MS4_C6’ corresponds to an event ‘Yoga workout’ running for a total duration of 1 hour. The multimedia service ‘MS4_C6’ is suggested to ‘User C’ since the personalized context data 219 of ‘User C’ indicates his interest in the multimedia service related to ‘Health’ and the favorite channel of the user is ‘Channel 6’.

Similarly, the multimedia service ‘MS2_C3’ (multimedia service telecasted at ‘Timeslot 2’ of ‘Channel 3’) corresponding to an event of ‘Regional Utsav’ and running for a total duration of 2 hours may be suggested to ‘User C’ based on the location details of the user comprised in the personalized context data 219 of ‘User C’.

In another embodiment, the personalized channel package may indicate multiple multimedia services at a single timeslot, thereby allowing the users to make a choice out of the available multimedia services in a single timeslot. Table C below shows an exemplary scenario in which the personalized channel package for ‘User C’ may indicate two multimedia services ‘MS2_C3’ and ‘MS5_C2’ in a single timeslot, ‘Timeslot 2’. As described above, the multimedia service ‘MS2_C3’ corresponding to the event of ‘Regional Utsav’ may be suggested to ‘User C’ based on the location details of the user comprised in the personalized context data 219 of ‘User C’. However, the event ‘MS5_C2’ corresponding to a ‘Cricket match’ and being telecasted in the same timeslot ‘Timeslot 2’ may also be suggested to the user if a particular cricket tournament and/or the match is gaining popularity in the social media. Thus, the users are given an option of viewing one of the most popular events, even when the personalized context data 219 of the user does not relate such a popular event.

TABLE C
Personalized channel package (comprising multiple
multimedia services at single timeslot)

| Timeslot 1 | Timeslot 2 | | Timeslot 3 | | Timeslot m |
|---|---|---|---|---|---|
| MS4_C6 | MS2_C3 | MS5_C2 | MS1_C1 | . . . | MSx_Cy |
| Event: Yoga | Event: Regional | Event: A cricket | Event: An action | | Event: |
| workout | Utsav | match | thriller movie | | |
| Length: 1.00 Hr. | Length: 0.5 Hrs. | Length: 3.00 Hrs. | Length: 2.5 Hrs. | | Length: |

In an embodiment, the package generation module 227 may generate a comprehensive personalized channel package for a billing period, for example 3 days, as shown in Table D below.

TABLE D
A comprehensive personalized channel package (For a billing period of 3 days)

| | | | |
|---|---|---|---|
| Timeslot 1 | Timeslot 2 | Timeslot 3 | Timeslot m |

On day 1 of billing period:

| | | | | | |
|---|---|---|---|---|---|
| MS4_C6 | MS2_C3 | MS5_C2 | MS1_C1 | . . . | MSx_Cy |
| Event: Yoga | Event: Regional | Event: A cricket | Event: An action | | Event: |
| workout | Utsav | match | thriller movie | | |
| Length: 1.00 Hr. | Length: 0.5 Hrs. | Length. 3.00 Hrs. | Length: 2.5 Hrs. | | Length: |

On day 2 of billing period:

| | | | | | |
|---|---|---|---|---|---|
| MS4_C6 | MS1_C4 | MS3_C6 | MS7_C1 | . . . | MSx_Cy |
| Event: Yoga | Event: A live | Event: A reality | Event: A soccer | | Event: |
| workout | concert | show | match | | |
| Length: 1.00 Hr. | Length: 2 Hrs. | Length: 1.5 Hrs. | Length: 1.5 Hrs. | | Length: |

On day 3 of billing period:

| | | | | |
|---|---|---|---|---|
| MS4_C6 | MS2_C3 | MS1_C2 | . . . | MSx_Cy |
| Event: Yoga | Event: A show on | Event: A news | | Event: |
| workout | supernatural powers | show | | |
| Length: 1.00 Hr. | Length: 3.5 Hrs. | Length: 2.5 Hrs. | | Length: |

As shown in Table D, the comprehensive personalized channel package may indicate one or more different multimedia services to the user at one or more timeslots in each day of the billing period. As an example, a multimedia service ‘MS2_C3’ corresponding to the event of ‘Yoga workout’ may be suggested on each day of the billing period if the personalized context data 219 of the user indicates that the user is highly interested in ‘Yoga workout’. Similarly, a multimedia service ‘MS2_C3’ corresponding to an event of ‘Regional Utsav’ (suggested on ‘Timeslot 2’ of day 1) may be replaced by another multimedia service ‘MS1_C4’ corresponding to an event of ‘Live concert’ on the second day (at ‘Timeslot 2’) of the billing period if the personalized context data 219 of the user indicates interest of the user towards ‘Music’. Similarly, the one or more multimedia services may be changed dynamically in each day of the billing period based on the personalized context data 219 of the user.

In an embodiment, the optimal cost determination module 229 may determine an optimal cost of subscribing the one or more channels in the personalized channel package provided to the user. Further, the optimal cost determination module 229 may allow the user to modify the personalized channel package based on one or more predetermined business rules for determining an optimal subscription cost for the personalized channel package. As an example, one of the predetermined business rules may include providing the time-based channel package to the user.

For an instance, consider a user who wants to minimize the total cost of subscription on the personalized channel package suggested to him. Suppose, the per-month subscription cost of a channel, ‘Channel X’ comprised in the personalized channel package of the user is comparatively higher than other channels in the personalized channel package of the user. In such a scenario, the user may choose to remove/unsubscribe to ‘Channel X’ from the personalized channel package in order to reduce the total subscription cost. Alternatively, the user may also choose to subscribe ‘Channel X’ for a limited number of hours in a day, say, only when a particular multimedia service of utmost interest to the user is being telecasted in the ‘Channel X’. Thus, performing a time-based optimal modification to the personalized channel package, as explained above, reduces the overall subscription cost to the user during a billing period, even when the user is allowed to subscribe to all the multimedia services of his choice on the other hand.

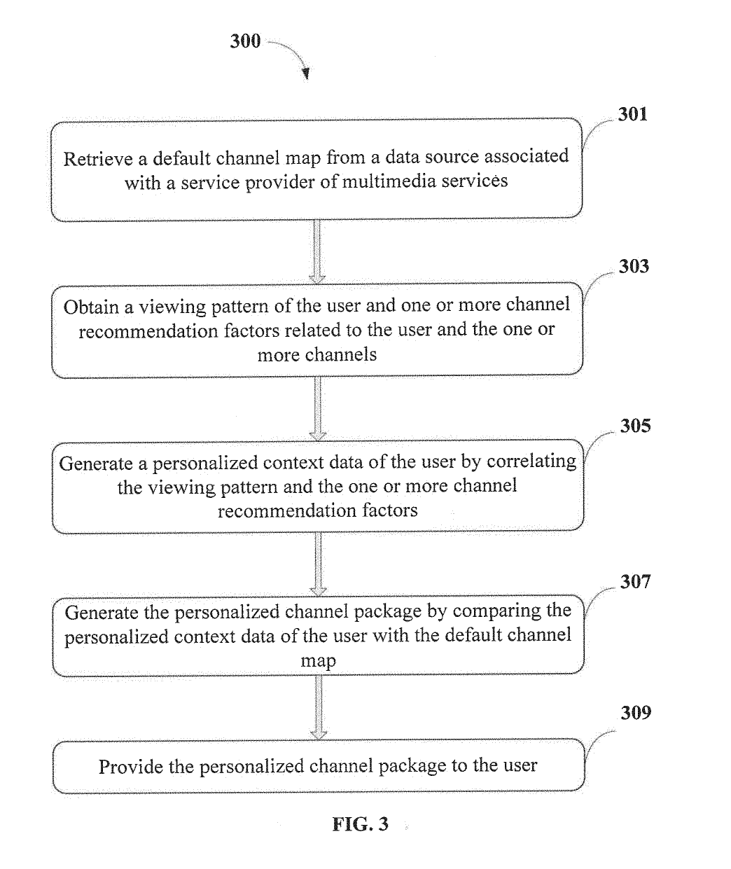

FIG. 3 shows a flowchart illustrating a method for dynamically providing a personalized channel package for multimedia services to a user in accordance with some embodiments of the present disclosure.

As illustrated in FIG. 3, the method 300 comprises one or more blocks for dynamically generating multimedia content file using a channel package generator 105. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, a channel package generator 105 retrieves a default channel map 211 from a data source 101 associated with a service provider 103 of multimedia services. The default channel map 211 comprises list of one or more channels providing multimedia services to the user.

At block 303, the channel package generator 105 obtains a viewing pattern 213 of the user and one or more channel recommendation factors 217 related to the user and the one or more channels. The viewing pattern 213 of the user may be classified based on at least one of the profile 215 of the user, the one or more channels viewed by the user, time of telecast of the multimedia services in the one or more channels and the one or more user devices 107 used by the user for viewing the one or more channels. In an embodiment, the profile 215 of the user comprises one or more details comprising at least one of age of the user, gender of the user, ethnicity of the user, geographic location of the user and login information of the user.

At block 305, the channel package generator 105 generates a personalized context data 219 of the user by correlating the viewing pattern 213 and the one or more channel recommendation factors 217. In an embodiment, the one or more channel recommendation factors 217 includes at least one of the demographic details related to the user, the favorite multimedia services viewed by the user, subscription cost of the one or more channels, trend in the multimedia services and the social media activities related to the user and the one or more channels.

At block 307, the channel package generator 105 generates the personalized channel package based on the personalized context data 219 of the user and the default channel map 211. In an embodiment, the user may also dynamically update the personalized channel package when required.

At block 309, the channel package generator 105 provides the personalized channel package to the user. Further, the channel package generator 105 determines the total subscription cost of the personalized channel package. In an embodiment, the channel package generator 105 may modify the personalized channel package based on one or more predetermined business rules for determining an optimal subscription cost for the personalized channel package.

### Computer System

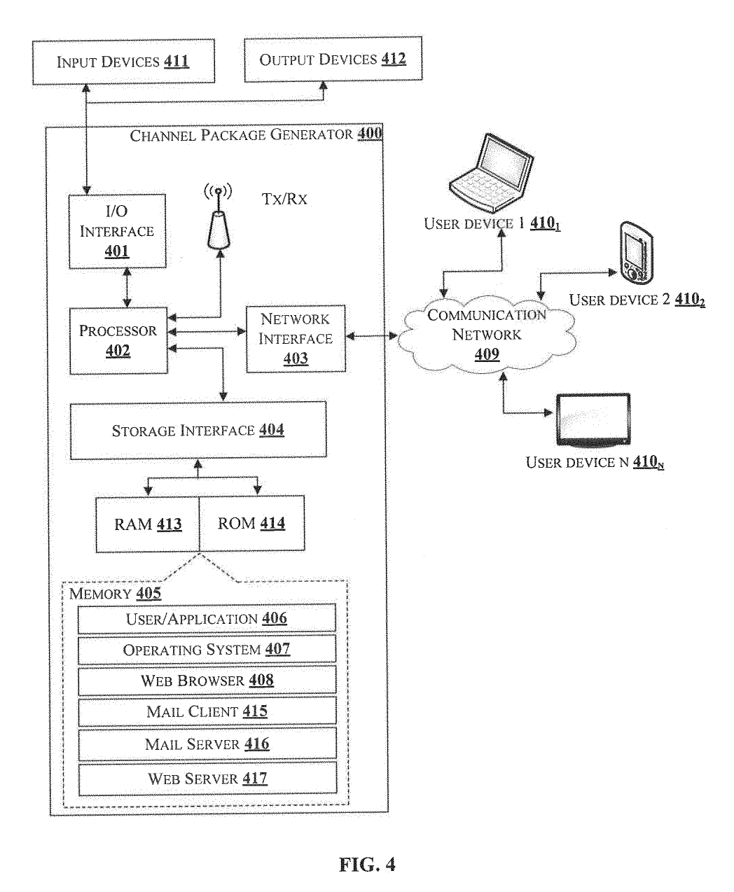

FIG. 4 illustrates a block diagram of an exemplary computer system 400 for implementing embodiments consistent with the present invention. In an embodiment, the computer system 400 may be the channel package generator 105 which is used for dynamically providing personalized package for the multimedia services to the user. The computer system 400 may comprise a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with one or more user devices 410 (1, . . . , n). The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more user devices 410 (1, . . . , n) may include, without limitation, personal computer(s), mobile devices such as cellular telephones, smartphones, tablet computers, eBook readers, laptop computers, notebooks, gaming consoles, or the like.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application data 406, an operating system 407, web server 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein.

In an embodiment, the present disclosure provides a method for dynamically generating a personalized channel package for multimedia services based on viewing pattern and personalized context of a user.

In an embodiment, the method of present disclosure allows a service provider of the multimedia services to build a context based channel package to the users, thereby increasing the net ARPU.

In an embodiment, the method of present disclosure provides flexibility to the users in dynamically selecting, subscribing and managing one or more channels as per the user's current requirements.

In an embodiment, the method of present disclosure employs an optimal costing technique in order to reduce total subscription cost to the user during a billing period.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Data source |
| 103 | Service provider of multimedia services |
| 105 | Channel package generator |
| 106 | Customer Premises Equipments (CPE) device |
| 107 | User devices |
| 111 | Data collection module |
| 113 | Communication interface |
| 115 | Human Machine Interaction (HMI) interface |
| 201 | I/O Interface |
| 203 | Memory |
| 205 | Processor |
| 207 | Data |
| 209 | Modules |
| 211 | Default channel map |
| 213 | Viewing pattern |
| 215 | User profile |
| 217 | Channel recommendation factors |
| 219 | Personalized context data |
| 221 | Other data |
| 223 | Receiving module |
| 225 | Context evaluation module |
| 227 | Package generation module |
| 229 | Optimal cost determination module |
| 231 | Other modules |

We claim:

1. A method for dynamically providing a personalized channel package for multimedia services to a user, the method comprising:
retrieving, by a channel package generator (105), a default channel map (211) from a data source (101) associated with a service provider (103) of multimedia services, wherein the default channel map (211) comprises list of one or more channels providing multimedia services to the user;
obtaining, by the channel package generator (105), a viewing pattern (213) of the user and one or more channel recommendation factors (217) related to the user and the one or more channels;
generating, by the channel package generator (105), a personalized context data (219) of the user by correlating the viewing pattern (213) and the one or more channel recommendation factors (217);
generating, by the channel package generator (105), the personalized channel package based on the personalized context data (219) of the user and the default channel map (211); and
providing, by the channel package generator (105), the personalized channel package to the user.

2. The method as claimed in claim 1, wherein the one or more channel recommendation factors (217) includes at least one of demographic details related to the user, one or more events occurring in nearby location of the user, favorite multimedia services viewed by the user, time of telecast of the multimedia services, subscription cost of the one or more channels, trend in the multimedia services and social media activities related to the user and the one or more channels.

3. The method as claimed in claim 1 enables the user for dynamically updating the personalized channel package.

4. The method as claimed in claim 1, wherein the viewing pattern (213) of the user is classified based on at least one of profile (215) of the user, the one or more channels viewed by the user, time of telecast of the multimedia services in the one or more channels and one or more devices (107) used by the user for viewing the one or more channels.

5. The method as claimed in claim 4, wherein the profile (215) of the user comprises one or more details comprising at least one of age of the user, gender of the user, ethnicity of the user, geographic location of the user and login information of the user.

6. The method as claimed in claim 1 further comprises determining subscription cost of the personalized channel package.

7. The method as claimed in claim 6 further comprises modifying the personalized channel package based on one or more predetermined business rules for determining an optimal subscription cost for the personalized channel package.

8. A channel package generator (105) for dynamically providing a personalized channel package for multimedia services to a user, the channel package generator (105) comprising:
a processor (205); and
a memory (203) communicatively coupled to the processor (205), wherein the memory (203) stores processor-executable instructions, which, on execution, causes the processor (205) to:
retrieve a default channel map (211) from a data source (101) associated with a service provider (103) of multimedia services, wherein the default channel map (211) comprises list of one or more channels providing multimedia services to the user;
obtain a viewing pattern (213) of the user and one or more channel recommendation factors (217) related to the user and the one or more channels;
generate a personalized context data (219) of the user by correlating the viewing pattern (213) and the one or more channel recommendation factors (217);
generate the personalized channel package based on the personalized context data (219) of the user and the default channel map (211); and
provide the personalized channel package to the user.

9. The channel package generator (105) as claimed in claim 8, wherein the one or more channel recommendation factors (217) includes at least one of demographic details related to the user, one or more events occurring in nearby location of the user, favorite multimedia services viewed by the user, time of telecast of the multimedia service, subscription cost of the one or more channels, trend in the multimedia services and social media activities related to the user and the one or more channels.

10. The channel package generator (105) as claimed in claim 8 enables the user to dynamically update the personalized channel package.

11. The channel package generator (105) as claimed in claim 8, wherein the instructions further cause the processor (205) to classify the viewing pattern (213) of the user based on at least one of profile (215) of the user, the one or more channels viewed by the user, time of telecast of the multimedia services in the one or more channels and one or more devices (107) used by the user for viewing the one or more channels.

12. The channel package generator (105) as claimed in claim 11, wherein the profile (215) of the user comprises one or more details including at least one of age of the user, gender of the user, ethnicity of the user, geographical location of the user and login information of the user.

13. The channel package generator (105) as claimed in claim 8, wherein the instructions further causes the processor (205) to determine subscription cost of the personalized channel package.

14. The channel package generator (105) as claimed in claim 13, wherein the instructions further cause the processor (205) to modify the personalized channel package based on one or more predetermined business rules to determine an optimal subscription cost for the personalized channel package.

15. A non-transitory computer-readable medium storing instructions for dynamically providing a personalized channel package for multimedia services to a user, wherein upon execution of the instructions by one or more processors, the processors perform operations comprising:
retrieve a default channel map (211) from a data source (101) associated with a service provider (103) of multimedia services, wherein the default channel map (211) comprises list of one or more channels providing multimedia services to the user;
obtain a viewing pattern (213) of the user and one or more channel recommendation factors (217) related to the user and the one or more channels;
generate a personalized context data (219) of the user by correlating the viewing pattern (213) and the one or more channel recommendation factors (217);
generate the personalized channel package based on the personalized context data (219) of the user and the default channel map (211); and
provide the personalized channel package to the user.

16. The medium as claimed in claim 15, wherein the one or more channel recommendation factors (217) includes at least one of demographic details related to the user, one or more events occurring in nearby location of the user, favorite multimedia services viewed by the user, time of telecast of the multimedia service, subscription cost of the one or more channels, trend in the multimedia services and social media activities related to the user and the one or more channels.

17. The medium as claimed in claim 15, wherein the instructions enable the user to dynamically update the personalized channel package

18. The medium as claimed in claim 15, wherein the instructions further classify the viewing pattern (213) of the user based on at least one of profile (215) of the user, the one or more channels viewed by the user, time of telecast of the multimedia services in the one or more channels and one or more devices (107) used by the user for viewing the one or more channels.

19. The medium as claimed in claim 18, wherein the profile (215) of the user comprises one or more details including at least one of age of the user, gender of the user, ethnicity of the user, geographical location of the user and login information of the user.

20. The medium as claimed in claim 15, wherein the instructions further modifies the personalized channel package based on one or more predetermined business rules to determine an optimal subscription cost for the personalized channel package.
